(19) United States
(12) Patent Application Publication
(10) Pub. No.: US 2018/0155073 A1
(43) Pub. Date: Jun. 7, 2018

(54) Vacuum Packaging Machine With Removable Internal And Low-Temperature "Sous Vide" Cooking Chamber

(71) Applicant: Fabio Emanuele Torre, Dalmine (IT)

(72) Inventor: Fabio Emanuele Torre, Dalmine (IT)

(21) Appl. No.: 15/886,603

(22) Filed: Feb. 1, 2018

Related U.S. Application Data
(63) Continuation of application No. 14/377,463, filed on Aug. 7, 2014, now abandoned.

(30) Foreign Application Priority Data
Feb. 23, 2012 (IT) TO2012A000159

(51) Int. Cl. B65B 29/08; B65B 31/02

(52) U.S. Cl. CPC B65B 29/08; B29C 66/8324; B65B 31/024

(57) ABSTRACT

A vacuum packaging machine (1) is described, with internal and “sous vide” cooking chamber composed of a supporting and containing structure (3) comprising at least one decompression chamber (7) for vacuum packaging and/or cooking a product (6) inside at least one bag (8) or other suitable container, such chamber (7) being composed of at least one tank (2) adapted to be closed by at least one cover (9), the cover (9) being equipped with a welding system (13) of the initially open edges (10) of the bag (8) composed of at least one welding bar (15) and at least one membrane system (16), and comprising at least one bulkhead (17) adapted to be inserted inside the tank (2) of the chamber (7), such bulkhead (17) being equipped on its top with at least one abutment bar (19) of the welding bar (15).

### CROSS-REFERENCE TO RELATED APPLICATIONS

This Application is a continuation of U.S. patent application Ser. No. 14/377,463, filed on Aug. 7, 2014, the contents of which are incorporated herein by reference in their entirety. Additionally, the application claims priority from International Patent Application No. PCT/IT2013/000006, titled “Vacuum Packaging Machine With Removable Internal and Low-Temperature “Sous Vide” Cooking Chamber,” filed Jan. 9, 2013, which claims priority from Italian Patent Application TO2012A000159 filed Feb. 23, 2012, the contents of which are incorporated in this disclosure by reference in their entirety.

### FIELD OF THE INVENTION

The present invention refers to a vacuum packaging machine with removable internal and low-temperature “sous vide (vacuum)” cooking chamber, particularly aimed to be used in professional or house kitchens as help in storing and preparing foods.

### BACKGROUND

Vacuum packaging machines with internal chamber are known in the art: in general, packaging through such machines occurs by inserting the product to be packaged inside a bag made of plastic material or a suitable container for vacuum packaging, and placing the bag containing the product inside a decompression chamber composed of a tank and an oscillating bell comprising elements suitable for welding the bag or the container and for keeping vacuum inside such tank. Such known packaging machines with internal chamber however have the following problems, that make extremely difficult, if not impossible, to use them in professional or house kitchens as help in storing and preparing foods:

excessive overall sizes and weight;

the internal chamber requires ribs and great thickness to oppose the depression that is created inside the machine during its cycle;

the internal chamber is fastened to the machine body, and cannot be removed for a deep cleaning;

costs are relatively high if compared with current technology of vacuum machines with external suction mainly used in house kitchens;

vacuum machines with external suction require embossed bags that are more costly than smooth bags;

vacuum machines with external suction do not allow packaging liquid products;

vacuum machines with external suction do not allow arriving at residual pressures lower than 100 mBar;

moreover, vacuum machines with external suction do not allow cooking foods with the “sous vide” (vacuum) technique.

### BRIEF DESCRIPTION OF THE DRAWINGS

The present invention will be better described by some preferred embodiments thereof, provided as a non-limiting example, with reference to the enclosed drawings, in which:

FIG. 1 shows a front perspective view of a preferred embodiment of the machine with internal chamber according to the present invention;

FIG. 2 shows a front view of the machine of FIG. 1;

FIG. 3 shows a sectional view of the machine of FIG. 1 with closed and open cover;

FIGS. 4a, 4b, 4c and 4d show different steps of the extraction of the internal tank of the machine of FIG. 1;

FIG. 5 shows an air-tightly sealed bag containing the product vacuum packaged through the machine according to the present invention.

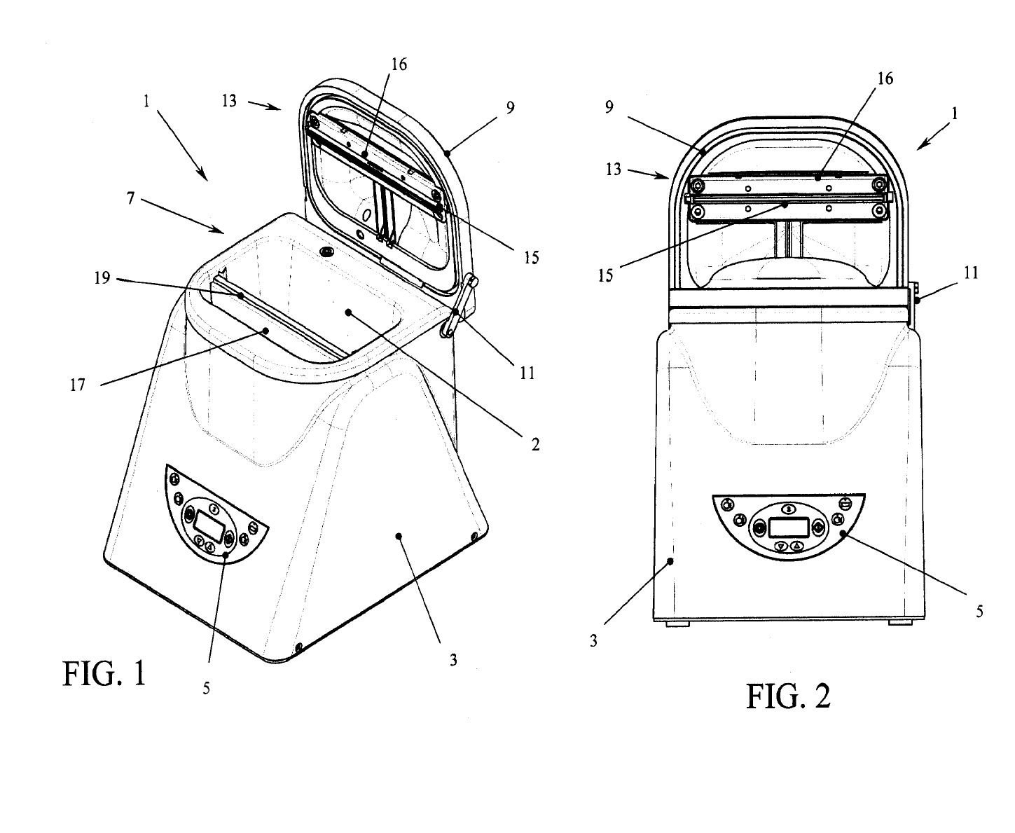

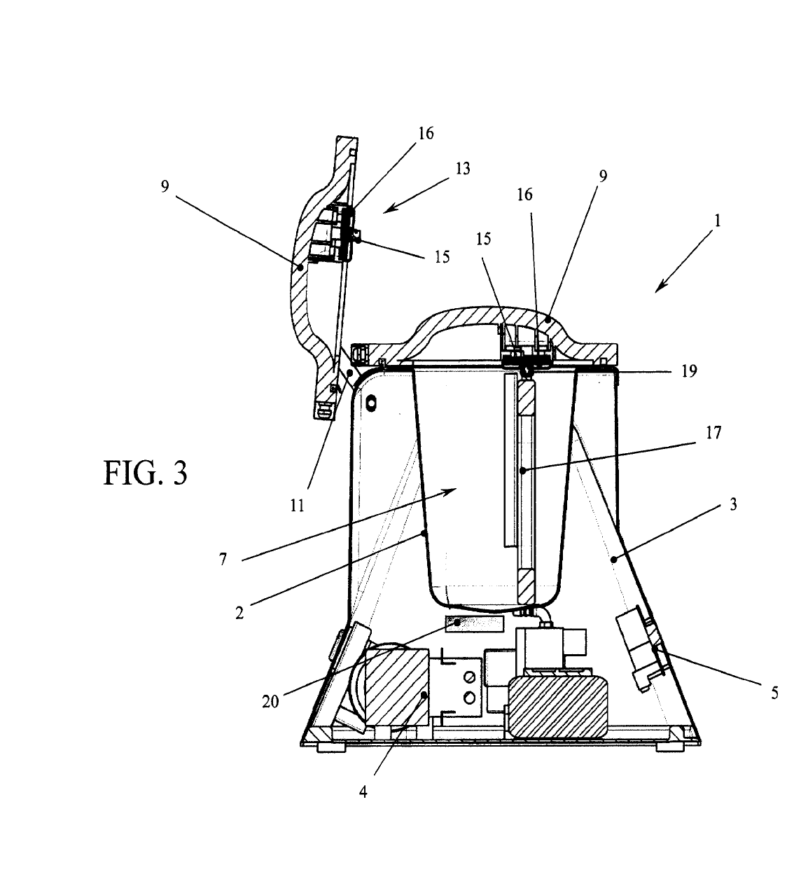

### SUMMARY

Therefore, object of the present invention is solving the above prior art problems by providing a vacuum packaging machine with removable internal and low-temperature “sous vide” cooking chamber, aimed in particular to be used in professional or house kitchens as help in storing and preparing foods.

Another object of the present invention is providing a vacuum packaging machine with removable internal and low-temperature “sous vide” cooking chamber, with reduced sizes and weights, that allow its use also in professional house kitchens in short spaces.

Moreover, an object of the present invention is providing a vacuum packaging machine with removable internal and low-temperature cooking chamber that is more versatile with respect to prior known machines, able to allow its user to use standard smooth bags present on the market and be also able to package liquid products.

Another object of the present invention is providing a vacuum packaging machine with removable internal and low-temperature “sous vide” cooking chamber that allows preparing cooked plates through the known “sous vide” technique or the technique with steam in microwaves through the use of suitable bags.

Moreover, an object of the present invention is providing a vacuum packaging machine with removable internal and low-temperature “sous vide” cooking chamber that allows packaging one or more bags in a single cycle with the same welding bar.

Another object of the present invention is providing a vacuum packaging machine with removable internal and low-temperature “sous vide” cooking chamber in which the internal tank is more efficient in terms of resistance to external pressure, thereby allowing relatively low thicknesses and reduced manufacturing costs.

Moreover, an object of the present invention is providing a vacuum packaging machine with removable internal and low-temperature “sous vide” cooking chamber that allows using suitable containers adapted to be inserted into the internal chamber and to keep vacuum therein.

The above and other objects and advantages of the invention, as will appear from the following description, are obtained with a vacuum packaging machine with removable internal and low-temperature “sous vide” cooking chamber as claimed in claim 1. Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) could me made to what is described, without departing from the scope of the invention as appears from the enclosed claims.

### DETAILED DESCRIPTION OF THE INVENTION

Herein below in the description, due to obvious conciseness reasons, all structural and operating details of the machine 1 that are known and belonging to the state of the art, will not be described.

With reference to the Figures, it is possible to note that the machine 1 according to the present invention is composed of a supporting and containing structure 3, obviously adapted to contain therein all functional members 4 of the machine 1 itself, that are substantially known in the art, and possibly to externally support at least one command and control board 5 for the operation of the machine 1, such supporting and containing structure 3 comprising at least one decompression chamber 7 for packaging and/or vacuum cooking a product 6, for example inside at least one bag 8 made of plastic material or another suitable container, such chamber 7 being composed of at least one tank 2 adapted to be closed by at least one cover 9. Obviously, the functional members comprise at least one vacuum pump adapted to suck, once having closed the tank 2 with the cover 9, air contained in the chamber 7 to create vacuum therein.

Advantageously, the cover 9 is equipped with a welding system 13 of the substantially open edges 10 of the bag 8 made of plastic material composed of at least one welding bar 15 and at least one membrane system 16 to create the necessary pressure adapted to guarantee an air-tight welding 12 onto the bag 8 made of plastic material. Obviously, the welding bar 15 and the membrane system 16 are electrically and pneumatically connected to the functional members 4 of the machine 1 according to the present invention. Moreover, the machine 1 according to the present invention comprises at least one cross-member, preferably made as at least one bulkhead 17, adapted to be inserted, in case of a bulkhead 17 preferably in a substantially vertical position, inside the tank 2 of the chamber 7, such cross-member being equipped with at least one abutment bar 19 of the welding bar 15. Preferably, such abutment bar 19 is arranged over such cross-member or such bulkhead 17.

The welding imprint 12 therefore occurs due to the pressure exerted by the membrane system joined to the temperature reached by the welding bar 15 through a pulse electronically controlled by the functional members 4.

Advantageously, the bag 8 is of the smooth and not embossed type: in such a way, the use of the machine 1 according to the present invention is more versatile, since it allows the user to employ standard bags that can be found everywhere, and therefore the packaging cost has a limited incidence.

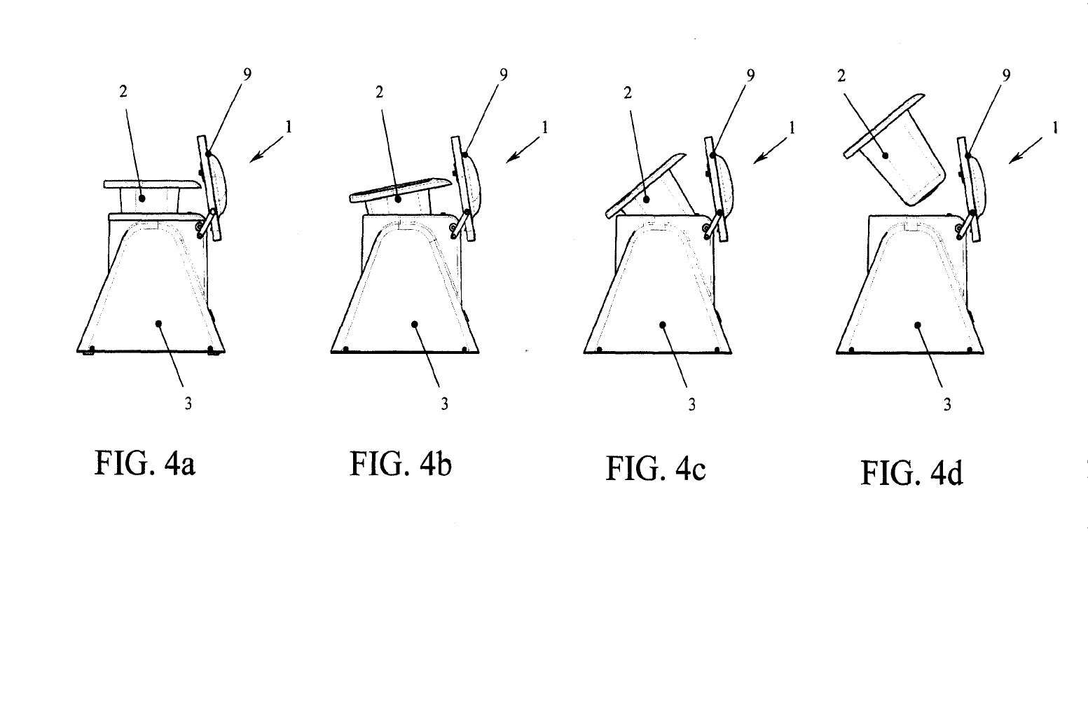

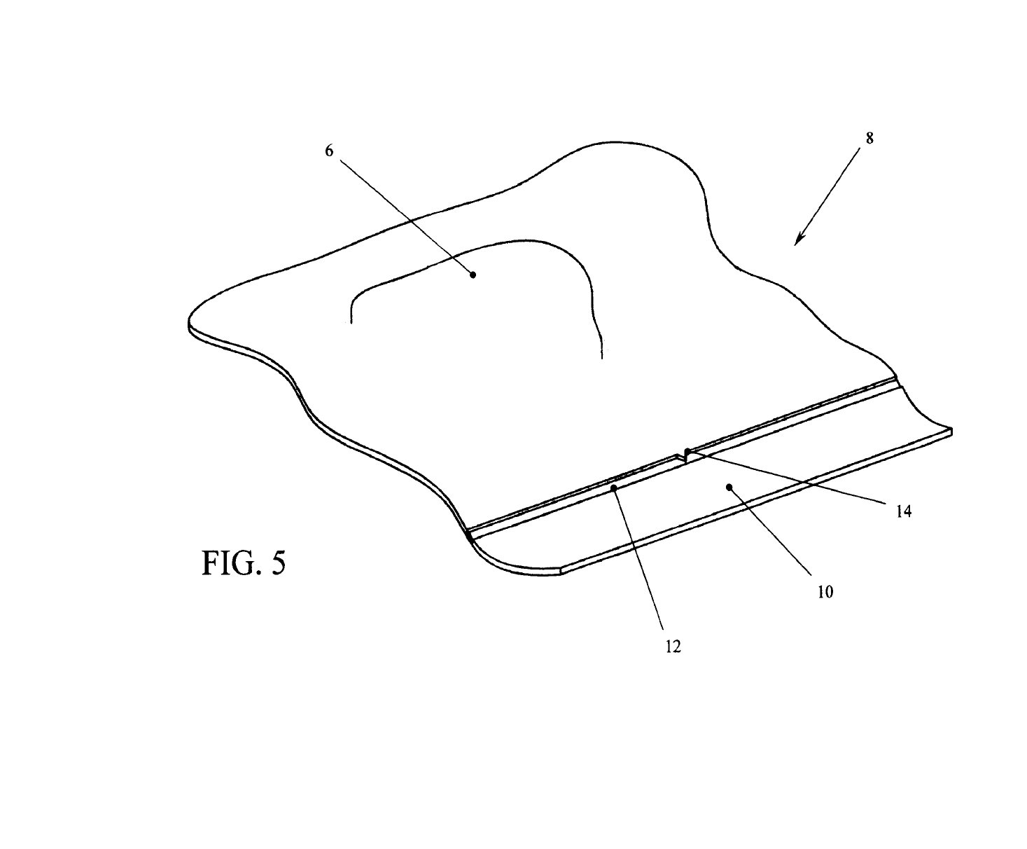

The cover 9 is, preferably, of the oscillating type and is connected to the supporting and containing structure 3 through suitable hinge-type kinematisms 11. In addition, as it is possible to note in particular in FIGS. 4a to 4d, it is possible to provide that the tank 2 can be extracted from the supporting and containing structure 3, for example to allow cleaning and washing it.

Preferably, the supporting and containing structure 3 of the machine 1 according to the present invention is made of moulded or thermoformed plastic material, while the tank 2 can also be made of plastic material or of AISI 304 steel.

In order to vacuum package a product 6 placed inside the bag 8 through the machine 1 according to the present invention it is therefore enough to proceed as follows:

inserting the bag 8 vertically inside the tank 2 by bending the edge 10 of the bag itself onto the abutment bar 19 of the cross-member, and in particular of the bulkhead 17: if the product 6 is not very big, another bag 8 can be placed thereon, containing another product 6, bending in the same way the edge 10 thereof on the abutment bar 19;

closing the cover 9 on the tank 2 thereby making the decompression chamber 7: the machine 1 is therefore ready to be started with its vacuum cycle: once having set the operating parameters of the machine 1 through the command and control board (such as welding time, vacuum percentage, number of previously saved program, vacuum function for rigid containers, etc.), the vacuum cycle is activated. During this step, the vacuum pump inside the machine is activated and consequently air inside the chamber 7, and therefore inside the bag 8, is sucked, preferably reaching a limit value of residual pressure that is lower than 100 mBar. Once having reached the preset value (controlled, for example, by a suitable pressure sensor connected with the chamber 7 interior), the functional members 4 take care of opening a solenoid valve, pneumatically connected to the membrane system 16, which, being at the atmospheric pressure (therefore higher than the pressure inside the chamber 7) presses the welding bar 15 onto the edge/s 10 of the bag/e 8 supported by the abutment bar 19. Simultaneously, an electric pulse is activated to the welding bar, that lasts for the necessary time preset through the board 5 adapted to melt and weld the different layers of the bag 8, creating an air-tight welding 12 thereof. Once having welded the bag 8, the cycle is completed by activating another solenoid valve, whose purpose is taking back the pressure inside the chamber 7 to atmospheric values, allowing to open the cover 9 and extract the vacuum packaged product/s 6.

If instead it is necessary to package the product inside known containers suitable to keep vacuum therein, one or more of such containers can be directly inserted inside the chamber 7: in such a way, it is possible to provide that the cross-member, and in particular the bulkhead 17, can be extracted from the tank 2 in order to increase the internal sizes of the chamber 7 itself. Afterwards, vacuum is created inside the chamber 7 as previously described.

In addition, in order to allow a “sous vide” cooking of the product 6 contained inside the bag 8 made of plastic material or other suitable container and placed inside the chamber 7, the machine 1 according to the present invention further comprises low-temperature or “sous vide” cooking means (<100° C.), preferably of the induction type, adapted to heat and mix water placed inside the tank 7 containing the packaged product.

Another possibility is steam cooking through the use of a microwave oven, since, for such purpose, the welding bar 15 comprises on its surface at least one notch (not shown) adapted to make along the welding imprint 12 obtained by the bar 15 itself onto the bag 8, at least one cutting point 14 having lower resistance: in this way, when the known cooking technique of the microwave is used to cook foods packaged with the machine 1 through the microwave cooking means, the pressure generated by evaporating the liquids inside the bag 8 breaks the welding imprint 12 next to the cutting point 14, that therefore operates as release valve of the excess steam. Foods are thereby cooked by steam inside the bag 8, that gradually goes out during the cooking step from the cutting point 14, avoiding risks of uncontrolled breakages of the bag 8 itself.

The machine 1 with vacuum packaging and “sous vide” cooking internal chamber according to the present invention, due in particular to its vertically positioning system of the bag 8 containing the product 6 inside the chamber 7 and to the welding and membrane systems embedded into the cover 9, occupies reduced spaces, that enable its use also in home kitchens as help in storing and preparing foods.

What is claimed is:

1. A vacuum packaging machine with internal and cooking chamber comprising:
a) at least one decompression chamber for vacuum packaging, cooking or both vacuum packaging and cooking a product inside at least one suitable container placed in a vertical position;
b) a supporting structure connected to the at least one decompression chamber; and
c) a containing structure connected to the supporting structure.

2. The machine of claim 1, wherein the at least one decompression chamber comprises at least one tank adapted to be closed by at least one cover.

3. The machine of claim 2, wherein the at least one cover is oscillating and is connected to the supporting and containing structure through hinge kinematisms.

4. The machine of claim 2, wherein the at least one cover comprises a welding system of edges of the the at least one suitable container, wherein the edges are initially open.

5. The machine of claim 4, wherein the welding system comprises at least one welding bar and at least one membrane system.

6. The machine of claim 5, wherein the welding bar comprises at least one notch on its surface adapted to obtain, along a welding imprint performed by the welding bar onto the at least one suitable container, at least one cutting point whose resistance is lower than a resistance of the bag.

7. The machine of claim 1 further comprising at least one cross-member adapted to be inserted inside the tank of the decompression chamber, wherein the cross-member is equipped with at least one abutment bar of the welding bar.

8. The machine of claim 7, wherein the cross-member is a bulkhead equipped on its top with the abutment bar.

9. The machine of claim 8, wherein the bulkhead is adapted to be extracted from the tank.

10. The machine of claim 1, wherein the tank is adapted to be extracted from the supporting and containing structure.

11. The machine of claim 1 further comprising a low-temperature cooking means adapted to heat and mix water placed inside the decompression chamber in order to perform a vacuum cooking of the product contained inside the at least one suitable container and placed inside the decompression chamber.

12. The machine of claim 1, wherein the supporting and containing structure are made of a molded plastic material, thermoformed plastic material or both a molded plastic material and thermoformed plastic material and the tank is made of plastic material.

13. The machine of claim 1, wherein the supporting and containing structure are made of a molded plastic material, thermoformed plastic material or both a molded plastic material and thermoformed plastic material and the tank is made of AISI 304 steel.

14. The machine of claim 1, wherein the at least one suitable container is a bag.
